(19) United States
(12) Patent Application Publication
(10) Pub. No.: US 2012/0061227 A1
(43) Pub. Date: Mar. 15, 2012

(54) STRUCTURE OF PRESS SWITCH

(76) Inventor: CHING-HSIUNG CHU, Taipei City (TW)

(21) Appl. No.: 12/945,898

(22) Filed: Nov. 15, 2010

(30) Foreign Application Priority Data
Sep. 9, 2010 (TW) 099217478

(51) Int. Cl. H01H 13/14

(52) U.S. Cl. 200/520

(57) ABSTRACT

An improved structure of a press switch includes a flexible flat cable connector provided in a base and connected to a circuit board. By pressing downward a housing of the improved structure, electrically conducting terminals on one lateral side of a movable seat are brought into contact with an electrically conducting element to establish electrical conduction. As the flat cable of the flexible flat cable connector is flexible, the pressing of the housing will not be hindered by the flexible flat cable, nor will the load of the pressing operation be increased.

### BACKGROUND OF THE INVENTION

1. Technical Field

The present invention relates to an improved structure of a press switch and, more particularly, to a switch structure which is electrically conducted by being pressed.

2. Description of Related Art

A press switch is turned on (electrically conducted) or off (electrically insulated) by successive press, or more specifically via a back-and-forth moving mechanism. However, when subjected to the load and pressure of such back-and-forth motion for along time, the resilient plates or terminals in the press switch may suffer from elastic fatigue or even break, thus resulting in poor electrical contact and reducing the service life of the press switch. Moreover, should any one of the resilient plates or terminals be damaged, it is impossible to replace only the damaged parts, for the resilient plates or terminals are fixedly embedded in the press switch. As a result, the entire press switch will have to be discarded.

### BRIEF SUMMARY OF THE INVENTION

The present invention provides an improved structure of a press switch. The improved structure includes a flexible flat cable connector provided in a base and connected to a circuit board supported on a fixing frame. By pressing a housing of the improved structure, the fixing frame in the housing is moved downward and drives a movable seat to move downward, too. In consequence, electrically conducting terminals on one lateral side of the movable seat are brought into contact with an electrically conducting element to establish electrical conduction. As the flat cable of the flexible flat cable connector is flexible and can change its configuration when vertically moved, the pressing of the housing will not be hindered by the flexible flat cable, nor will the load of the pressing operation be increased.

### BRIEF DESCRIPTION OF THE SEVERAL VIEWS OF THE DRAWINGS

A detailed description of further features and advantages of the present invention is given below with reference to the accompanying drawings, in which:

FIG. 1 is an assembled perspective view of the present invention;

FIG. 2 is an exploded perspective view of the present invention;

FIG. 3 is a partial exploded perspective view of the present invention;

FIG. 4 is another exploded perspective view of the present invention;

FIG. 5 is a sectional view of the present invention; and

FIG. 6 is a sectional view showing the present invention in use.

### DETAILED DESCRIPTION OF THE INVENTION

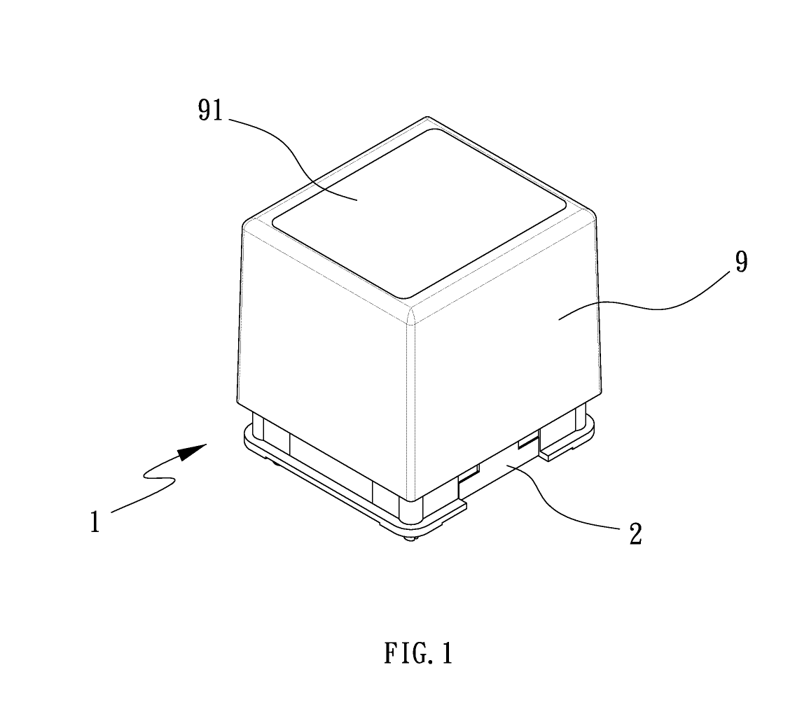

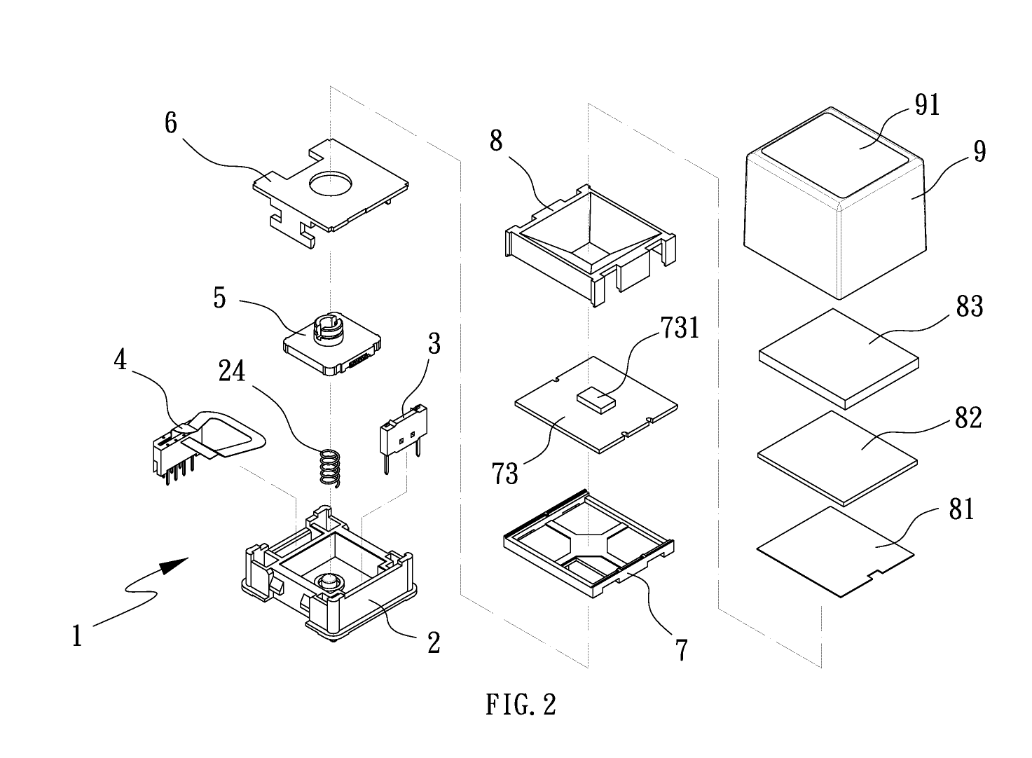

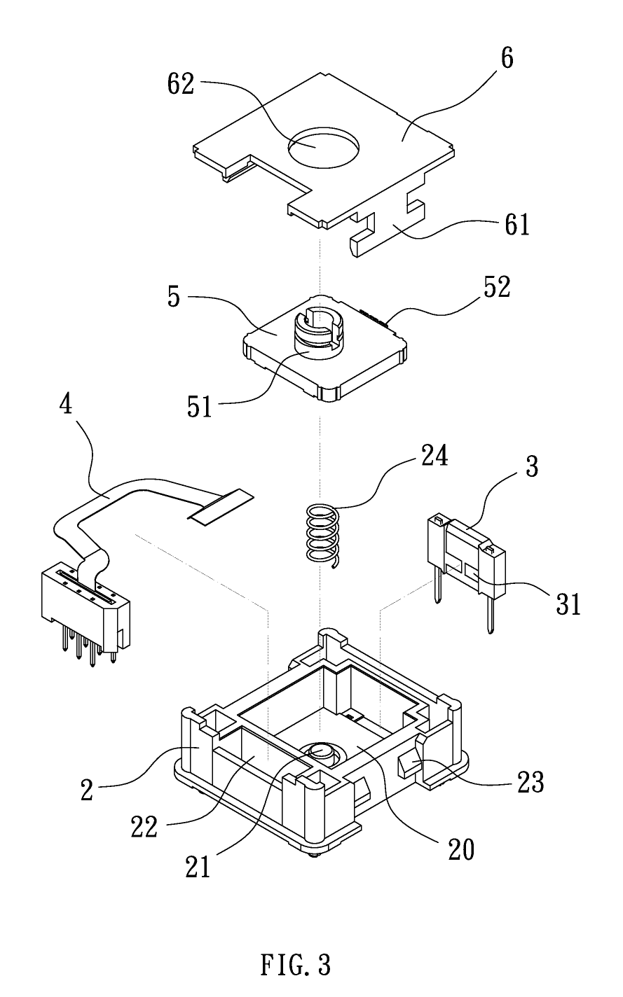

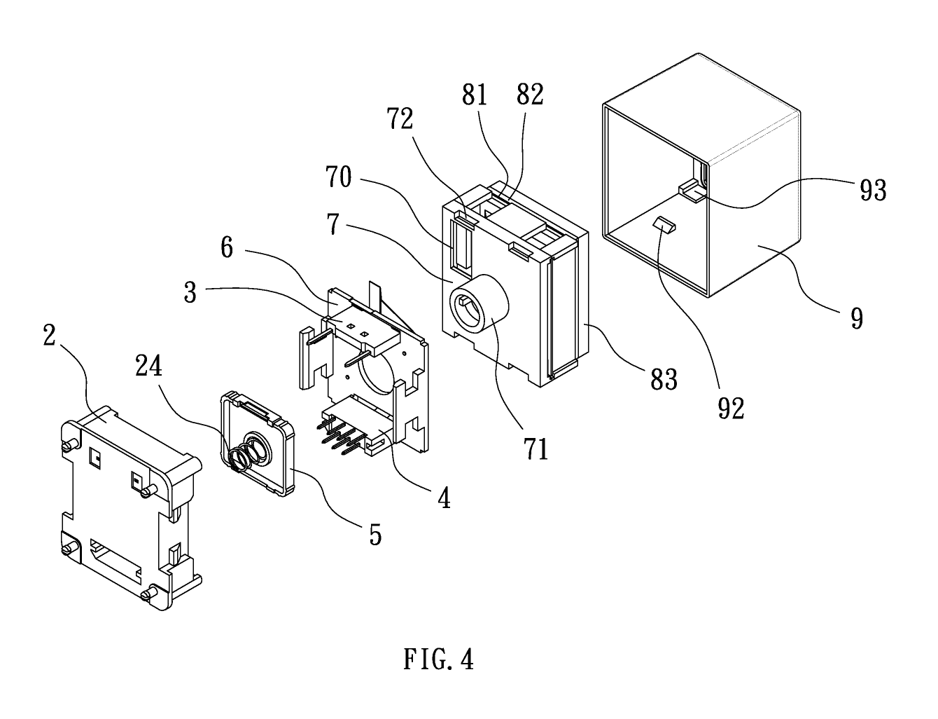

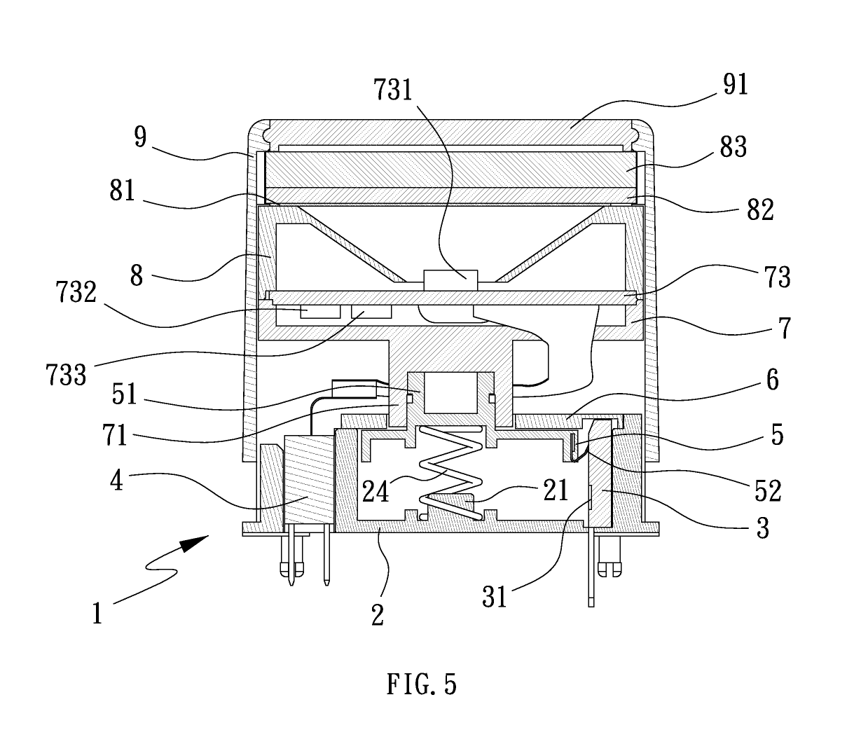

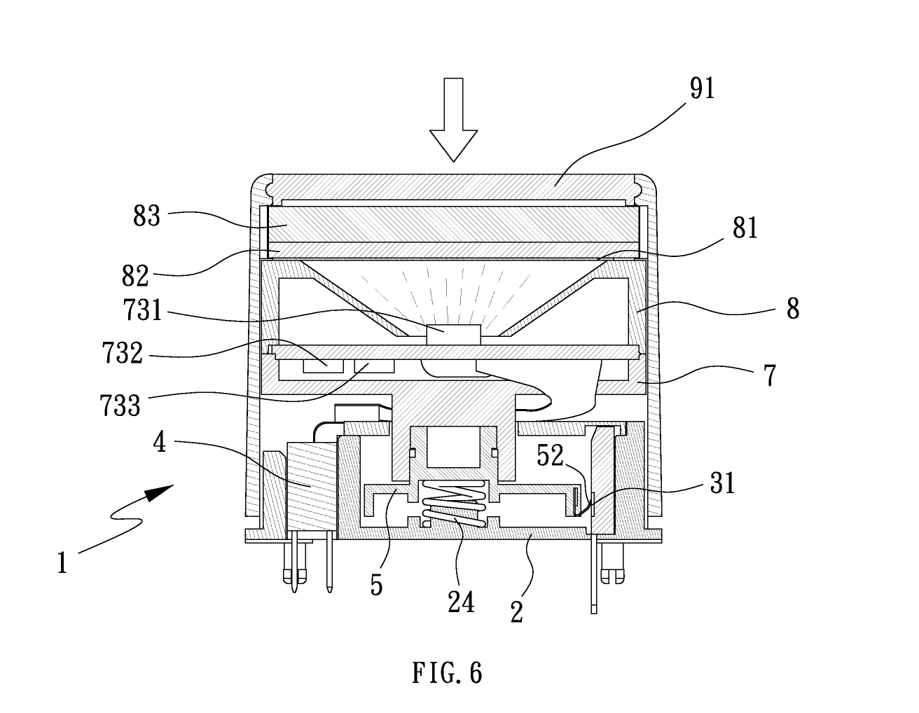

Please refer to FIGS. 1 through 6 for an assembled perspective view, two exploded perspective views, a partial exploded perspective view, and two sectional views of the present invention. As shown in the drawings, a press switch 1 according to the present invention includes a base 2, an electrically conducting element 3, a flexible flat cable connector 4, a movable seat 5, a bottom cover 6, a fixing frame 7, a circuit board 73, a light-converging element 8, a light-emitting diode (LED) screen 83, and a housing 9.

The base 2 defines therein a receiving space 20 and a receiving groove 22. The receiving space 20 is provided with a protruding block 21, and the protruding block 21 is installed with a resilient element 24. Each of two opposite outer lateral sides of the base 2 is formed with at least one protuberance 23.

The electrically conducting element 3 is inserted in a lateral portion of the receiving space 20 of the base 2. A plurality of electrically conducting terminals 31 are provided on a lateral side of the electrically conducting element 3.

The flexible flat cable connector 4 is inserted in the receiving groove 22 of the base 2.

The movable seat 5, which is disposed in the receiving space 20 of the base 2, has one side extended with a projecting end 51 and a lateral side provided with a plurality of electrically conducting terminals 52.

The bottom cover 6 has two opposite edges, each extended with an engaging ear 61. Besides, the bottom cover 6 is centrally formed with a through hole 62. The engaging ears 61 are engaged with the protuberances 23 of the base 2 respectively such that the bottom cover 6 is installed on and covers the base 2.

The fixing frame 7 has a lateral portion formed with a through hole 70. The flexible flat cable connector 4 can pass through the through hole 70 in order to be connected with the circuit board 73. The fixing frame 7 also has a side extended with a connecting end 71. The connecting end 71 is inserted through the through hole 62 of the bottom cover 6 and is connected with the projecting end 51 of the movable seat 5. In addition, each of two opposite outer lateral sides of the fixing frame 7 is formed with at least one recess 72.

The circuit board 73 is supported on the fixing frame 7 and is equipped with at least one light-emitting element 731, a microcontroller 732, and a memory element 733, wherein the light-emitting element 731 is a full-color LED.

The light-converging element 8 is provided on an upper side of the circuit board 73. A light-diffusing plate 81 and a phosphor plate 82 are provided between the light-converging element 8 and the LED screen 83.

The LED screen 83 is disposed on an upper side of the light-converging element 8.

The housing 9 covers the base 2 and is embedded with a transparent cover 91. The inner wall of the housing 8 is provided with a plurality of projecting blocks 92 and a plurality of positioning members 93.

When the base cover 6 is in place to cover the base 2, the projecting end 51 of the movable seat 5 inside the base 2 juts out of the through hole 62 of the base cover 6. On the other hand, the recesses 72 on two opposite outer lateral sides of the fixing frame 7 are engaged respectively with the projecting blocks 92 on the inner wall of the housing 9 such that the fixing frame 7 and the components mounted thereon (namely the circuit board 73, the light-converging element 8, the light-diffusing plate 81, the phosphor plate 82, and the LED screen 83) are securely disposed in the housing 9. Once the phosphor plate 82 and the LED screen 83 are placed in the housing 9, the plural positioning members 93 on the inner wall of the housing 9 are engaged with the edges of the phosphor plate 82 and the LED screen 83, thereby fixing the phosphor plate 82 and the LED screen 83 in position and increasing their stability.

As the projecting end 51 of the movable seat 5 is connected with the connecting end 71 of the fixing frame 7, the fixing frame 7 in the housing 9 will be moved downward and drive the movable seat 5 downward as well when the housing 9 is pressed. Therefore, by pressing the housing 9, the electrically conducting terminals 52 on one lateral side of the movable seat 5 are brought into contact with the electrically conducting terminals 31 of the electrically conducting element 3, and the press switch 1 is thus electrically conducted. Moreover, as the flexible flat cable of the flexible flat cable connector 4 in the base 2 is inserted through the through hole 70 of the fixing frame 7 and then connected to the circuit board 73 on the fixing frame 7, both the light-emitting element 731 on the circuit board 73 and the LED screen 83 are powered through the flexible flat cable connector 4. In addition, due to the flexibility and the U-shaped design of the flat cable of the flexible flat cable connector 4, the pressing of the press switch 1 will not be hindered by the flexible flat cable, nor will the load of the pressing operation be increased.

Light emitted by the light-emitting element 731 is converged by the light-converging element 8 while the four working surfaces of the light-converging element 8 allow the light to be projected uniformly. The light is subsequently diffused by the light-diffusing plate 81 and the phosphor plate 82 before being projected outward. The memory element 733 on the circuit board 73 is configured for storing control programs, and the microcontroller 732 is configured for controlling the emission of different color lights by the light-emitting element 731. The different color lights are intended to work in conjunction with the characters or symbols displayed by the LED screen 83.

As mentioned previously, the electrically conducting element 3 and the flexible flat cable connector 4 are installed in the base 2 by way of insertion and are therefore detachable from the base 2. Should the electrically conducting element 3 or the flexible flat cable connector 4 be damaged, the damaged part can be removed from the base 2 for replacement and repair without having to discard the entire base 2. Besides, the transparent cover 91 is embedded in the housing 9 by insert molding, thus allowing the housing 9 to be free of gaps and effectively waterproof.

What is claimed is:

1. A structure of a press switch, comprising:
a base defining therein a receiving space and a receiving groove;
an electrically conducting element inserted in a lateral portion of the receiving space of the base;
a flexible flat cable connector inserted in the receiving groove of the base;
a movable seat provided in the receiving space of the base, the movable seat having a lateral side provided with a plurality of electrically conducting terminals, the movable seat further having a bottom portion provided with a resilient element;
a bottom cover provided on the base;
a fixing frame located above the movable seat;
a circuit board supported on the fixing frame;
a light-converging element provided on an upper side of the circuit board;
a light-emitting diode (LED) screen provided on an upper side of the light-converging element; and
a housing covering the base;
wherein the flexible flat cable connector is connected to the circuit board on the fixing frame, and, when the housing is pressed, the fixing frame in the housing is moved downward and drives the movable seat to also move downward such that the electrically conducting terminals on the lateral side of the movable seat are brought into contact with the electrically conducting element, thereby establishing electrical conduction to the circuit board and the LED screen.

2. The structure of claim 1, wherein the receiving space of the base is provided with a protruding block to which the resilient element is installed.

3. The structure of claim 1, wherein each of two opposite outer lateral sides of the base is provided with at least a protuberance.

4. The structure of claim 1, wherein the movable seat has a side provided with a projecting end.

5. The structure of claim 1, wherein the flexible flat cable connector has an end connected to the circuit board.

6. The structure of claim 1, wherein the bottom cover is formed with a through hole and has two opposite edges each extended with an engaging ear.

7. The structure of claim 1, wherein the fixing frame has a side provided with a connecting end and has two opposite outer lateral sides each provided with at least a recess.

8. The structure of claim 1, wherein the circuit board is provided with at least a light-emitting element, and each said light-emitting element is a full-color LED.

9. The structure of claim 1, wherein the circuit board is provided with a microcontroller and a memory element.

10. The structure of claim 1, further comprising a light-diffusing plate and a phosphor plate which are provided between the light-converging element and the LED screen.

11. The structure of claim 1, wherein the housing is embedded with a transparent cover and has an inner wall provided with a plurality of projecting blocks and a plurality of positioning members.
